(19) United States
(12) Patent Application Publication
(10) Pub. No.: US 2015/0083917 A1
(43) Pub. Date: Mar. 26, 2015

(54) INFRARED LIGHT DIRECTOR FOR GESTURE OR SCENE SENSING FSC DISPLAY

(71) Applicant: QUALCOMM Incorporated, San Diego, CA (US)

(72) Inventors: John Michael Wyrwas, Berkeley, CA (US); Paul Eric Jacobs, La Jolla, CA (US); Evgeni Petrovich Gousev, Saratoga, CA (US); Russell Wayne Gruhlke, Milpitas, CA (US); Chung-Po Huang, San Jose, CA (US); Hae-Jong Seo, San Jose, CA (US); Xiquan Cui, San Jose, CA (US); Jacek Maitan, Mountain View, CA (US)

(21) Appl. No.: 14/034,369

(22) Filed: Sep. 23, 2013

(51) Int. Cl. G02B 26/02; G01J 1/42

(52) U.S. Cl. CPC G02B 26/02; G01J 1/42; G01J 2001/4295
USPC 250/341.1; 250/353; 359/227

(57) ABSTRACT

This disclosure provides systems, methods and apparatus for touch and gesture recognition, using a field sequential color display. The display includes a processor, a lighting system, and an arrangement for spatial light modulation that includes a number of apertures, and devices for opening and shutting the apertures. A light directing arrangement includes at least one light turning feature. The display lighting system is configured to emit visible light and infrared (IR) light through at least a first opened one of the plurality of apertures. The light turning feature is configured to redirect IR light emitted through the opened aperture into at least one lobe, and to pass visible light emitted by the display lighting system through the opened aperture with substantially no redirection.

### TECHNICAL FIELD

This disclosure relates to techniques for touch and gesture recognition, and, more specifically, to a field sequential color (FSC) display that provides a user input/output interface, controlled responsively to a user's touch and/or gesture.

### DESCRIPTION OF THE RELATED TECHNOLOGY

Increasingly, electronic devices such as personal computers and personal electronic devices (PED's) provide for at least some user inputs to be provided by means other than physical buttons, keyboards, and point and click devices. For example, touch screen displays are increasingly relied upon for common user input functions. The display quality of touch screen displays, however, can be degraded by contamination from a user's touch. Moreover, when the user's interaction with the device is limited to a small two dimensional space, as is commonly the case with touch screen displays of, at least, PEDs, the user's input (touch) may be required to be very precisely located in order to achieve a desired result. This results in slowing down or otherwise degrading the user's experience with the device.

Accordingly, it is desirable to have a user interface that is responsive, at least in part, to “gestures” by which is meant, the electronic device senses and reacts in a deterministic way to gross motions of a user's hand, digit, or hand-held object. The gestures may be made proximate to, but, advantageously, not in direct physical contact with the electronic device.

Current commercially available gesture systems include camera-based, ultrasound and projective capacitive systems. Ultrasound systems suffer from resolution issues; for example, circular motion is difficult to track and individual fingers are difficult to identify. Projective capacitive systems yield good resolution near and on the surface of a display but are resolution limited further than about an inch from the display surface. Camera-based systems may provide good resolution at large distances and adequate resolution to within an inch of the display surface. However, the cameras are 1) placed on the periphery of the display and 2) have a limited field of view. As a result, gesture recognition cannot be achieved at or near the display surface.

Thus, improved techniques for providing a touch screen interface are desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a field sequential color (FSC) display, having a display front surface and a viewing area. The FSC display includes a display lighting system that includes at least one visible light emitter and at least one infrared (IR) light emitter. The FSC display also includes an arrangement for spatial light modulation, the arrangement including a plurality of apertures, and devices for opening and shutting the apertures. The FSC display also includes a light directing arrangement including at least one light turning feature. The display lighting system is configured to emit visible light and IR light through at least a first opened one of the plurality of apertures. The light turning feature is configured to redirect IR light emitted through the opened aperture into at least one lobe, and to pass visible light emitted by the display lighting system through the opened aperture with substantially no redirection.

In some implementations, the apparatus may further include a processor and at least one IR light sensor configured to output a signal representative of a characteristic of received IR light, the received IR light resulting from scattering of the at least one lobe of IR light by an object. The devices for opening and shutting the apertures may be switched in accordance with a first modulation scheme to render an image. The IR light sensor is configured to output, to the processor, a signal representative of a characteristic of the received IR light. The processor may be configured to switch the devices for opening and shutting the apertures in accordance with a second modulation scheme to selectively pass object illuminating IR light through at least one of the respective apertures, the object illuminating IR light being at least partially unrelated to the image; and recognize, from the output of the light sensor, a characteristic of the object.

Another innovative aspect of the subject matter described in this disclosure can be implemented in a method that includes switching, with a processor, one or more devices for opening and shutting apertures included in an arrangement for spatial light modulation. The devices for opening and shutting the apertures are switched in accordance with a first modulation scheme to render an image. A field sequential color (FSC) display has a display front surface and a viewing area, the FSC display including the arrangement for spatial light modulation. The FSC display includes a light directing arrangement including at least one light turning feature, the light turning feature being configured to redirect IR light emitted through the opened aperture into at least one lobe, and to pass visible light emitted by the display lighting system through the opened aperture with substantially no redirection. The FSC display also includes at least one infrared (IR) light sensor configured to output a signal representative of a characteristic of received IR light, the received IR light resulting from scattering of the at least one lobe of IR light by an object. The method includes emitting visible light and infrared (IR) light through at least a first opened one of the plurality of apertures and switching the devices for opening and shutting the apertures in accordance with a second modulation scheme to selectively pass object illuminating IR light through at least one of the respective apertures, the object illuminating IR light being at least partially unrelated to the image. The method also includes recognizing, with the processor, from the output of the light sensor, a characteristic of the object.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a block diagram of an example of an electronic device having an interactive display according to an implementation.

FIG. 1B shows a cross sectional view of an electronic display 110, according to an implementation.

FIG. 2 illustrates a schematic diagram of an example of an arrangement for spatial light modulation of an interactive display.

FIG. 3 is a cross sectional view of an interactive display incorporating a light modulation array.

FIG. 4 illustrates an example of an interactive display according to an implementation.

FIG. 5 illustrates an example of directionally structured lobes of object illuminating light.

FIG. 6 illustrates an example of an interactive display according to an implementation.

FIG. 7 illustrates a further example of an interactive display, according to an implementation.

FIG. 8 illustrates another example of an interactive display according to an implementation.

FIG. 9 illustrates a yet further example of an interactive display according to an implementation.

FIG. 10 illustrates an example of a scanning pattern for a second modulation scheme in accordance with some implementations.

FIG. 11 illustrates a further example of a scanning pattern for a second modulation scheme in accordance with some implementations.

FIG. 12 illustrates a technique for detecting a bright object, according to some implementations.

FIG. 13 illustrates a technique for detecting a dark object, according to some implementations.

FIG. 14 illustrates an example of a scanning strategy for the second modulation scheme in accordance with some implementation.

FIG. 15 illustrates an example of a process flow for touch and gesture recognition with an interactive FSC display according to an embodiment.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Described herein below are new techniques for an interactive display with improved user input/output functionality. In some implementations, a gesture-responsive user input/output (I/O) interface for an electronic device is provided. “Gesture” as used herein broadly refers to a gross motion of a user's hand, digit, or hand-held object, or other object under control of the user. The motion may be made proximate to, but not necessarily in direct physical contact with, the electronic device. In some implementations, the electronic device senses and reacts in a deterministic way to a user's gesture. In some implementations, a document scanning capability is provided.

Particular implementations of the subject matter described in this disclosure can be implemented to realize one or more of the following potential advantages. The presently disclosed techniques provide a significant improvement in touch and/or gesture I/O using an interactive field sequential color (FSC) display. The FSC display includes an array of light modulators configured to be individually switched between an open position that permits transmittance of light through a respective aperture and a shut position that blocks light transmission through the respective aperture. The interactive FSC display includes a transparent substrate, such as a glass or other transparent material, which has a rear surface proximate to which light sensors or other photo-sensitive elements are disposed. The interactive FSC display is configured to determine the location and/or relative motion of a user's touch or gesture proximate to the display, and/or to register an image of the object.

Particular implementations of the subject matter described in this disclosure can be implemented to realize one or more of the following potential advantages. The user's gesture may occur over a “full range” of view with respect to the interactive display. By “full range” is meant that the gesture may be recognized, at a first extreme, even when made very close to, or in physical contact with, the interactive display; in other words, “blind spots” exhibited by prior art camera systems are avoided. At a second extreme, the gesture may be recognized at a substantial distance, up to approximately 500 mm, from the interactive display, which is not possible with known projective capacitive systems. The above functionality may be provided by configuring the transparent substrate with light directing features, thereby avoiding the cost and thickness associated with adding an additional light-guide layer.

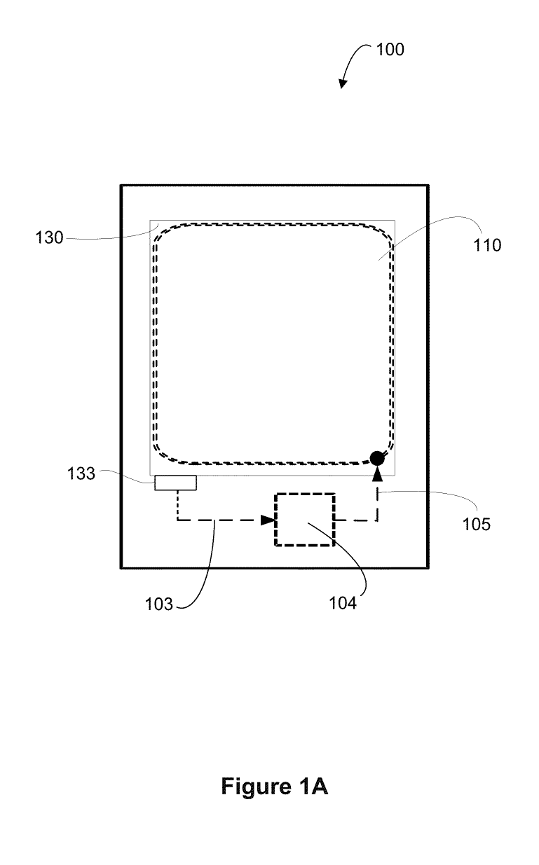

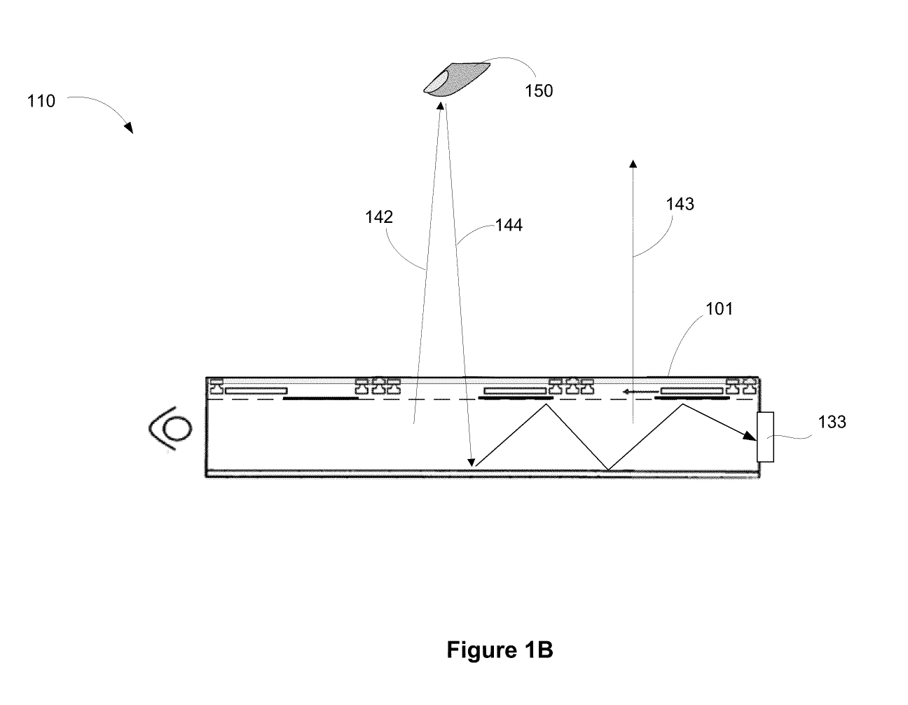

FIG. 1A shows a block diagram of an example of an electronic device having an interactive display according to an implementation. An apparatus 100, which may be, for example, a personal electronic device (PED), may include an electronic display 110 and a processor 104. The electronic display 110 may be a touch screen display, but this is not necessarily so. In some implementations, the processor 104 may be configured to control an output of the electronic display 110, or an electronic device (not shown) communicatively coupled with apparatus 100. The processor 104 may control the output of the electronic display 110 in response, at least in part, to a user input. The user input may include a touch or a gesture, where the user gesture may include, for example, a gross motion of a user's appendage, such as a hand or a finger, or a handheld object or the like. The gesture may be located, with respect to the electronic display 110, at a wide range of distances. For example, a gesture may be made proximate to, or even in direct physical contact with the electronic display 110. Alternatively, the gesture may be made at a substantial distance, up to, approximately 500 mm from the electronic display 110. In some implementations, the processor 104 may be configured to collect and process data received from the electronic display 110 regarding the user input. The data may include a characteristic of a touch, gesture, or object related to the user input. The characteristic may include location and motion information of a touch or a gesture, or image data, for example.

In some implementations, light sensor 133 may output one or more signals responsive to light reflected into the electronic display 110 from a user's appendage, or an object under the user's control, for example. In some implementations, signals outputted by light sensor 133, via a first signal path 103, may be analyzed by the processor 104 so as to recognize an instance of a user input, such as a touch or a gesture. The processor 104 may then control the electronic display 110, responsive to the user input, by way of signals sent to the electronic display 110 via a second signal path 105. In some implementations, signals outputted by the arrangement 130, via the first signal path 103, may be analyzed so as to obtain image data.

FIG. 1B shows a cross sectional view of an electronic display 110, according to an implementation. Although one light sensor 133 is shown in the illustrated implementation, it will be appreciated that numerous other arrangements are possible. Any number of light sensors may be used. Although the light sensor 133 is illustrated as located at the periphery of optical cavity 113, it may be located at, for example, on the top or as part of the display, along a bezel at the side of the display, at the bottom of the optical cavity 113, as well as other locations that could receive light scattered from object 150. The light sensor 133 may include one or more photosensitive elements, such photodiodes, phototransistors, charge coupled device (CCD) arrays, complementary metal oxide semiconductor (CMOS) arrays or other suitable devices operable to output a signal representative of a characteristic of detected visible light. The light sensor 133 may output signals representative of color of detected light, for example. In some implementations, the signals may also be representative of other characteristics, including intensity, polarization, directionality, frequency, amplitude, amplitude modulation, and/or other properties. The electronic display 110 may have a substantially transparent front surface 101 such that at least most light 143 from the electronic display 110 passes through the front surface 401 and may be observed by a user (not illustrated).

As illustrated in FIG. 1B, when an object 150 interacts with light 142 (which may be referred to herein as “object illuminating light”) from the electronic display 110, scattered light 144, resulting from the interaction, may be directed through front surface 401 and be received by light sensor 133. The object 150 may be, for example, a user's appendage, such as a hand or a finger, or it may be any physical object, hand-held or otherwise under control of the user but is herein referred to, for simplicity, as the “object.” The light sensor 133 may be configured to detect one or more characteristics of the scattered light 144, and output, to the processor 104, a signal representative of the detected characteristics. For example, the characteristics may include intensity, polarization, directionality, frequency, amplitude, amplitude modulation, and/or other properties.

Referring again to FIG. 1A, the processor 104 may be configured to receive, from the light sensor 133, signals representative of the detected characteristics, via the first signal path 103. The processor 104 may be configured to recognize, from the output signals of the light sensor 133, an instance of a user gesture. Moreover, the processor 104 may control one or more of the electronic display 110, other elements of the apparatus 100, and/or an electronic device (not shown) communicatively coupled with apparatus 100. For example, an image displayed on the electronic display 110 may be caused to be scrolled up or down, rotated, enlarged, or otherwise modified. In addition, the processor 104 may be configured to control other aspects of the apparatus 100, responsive to the user gesture, such as, for example, changing a volume setting, turning power off, placing or terminating a call, launching or terminating a software application, etc.

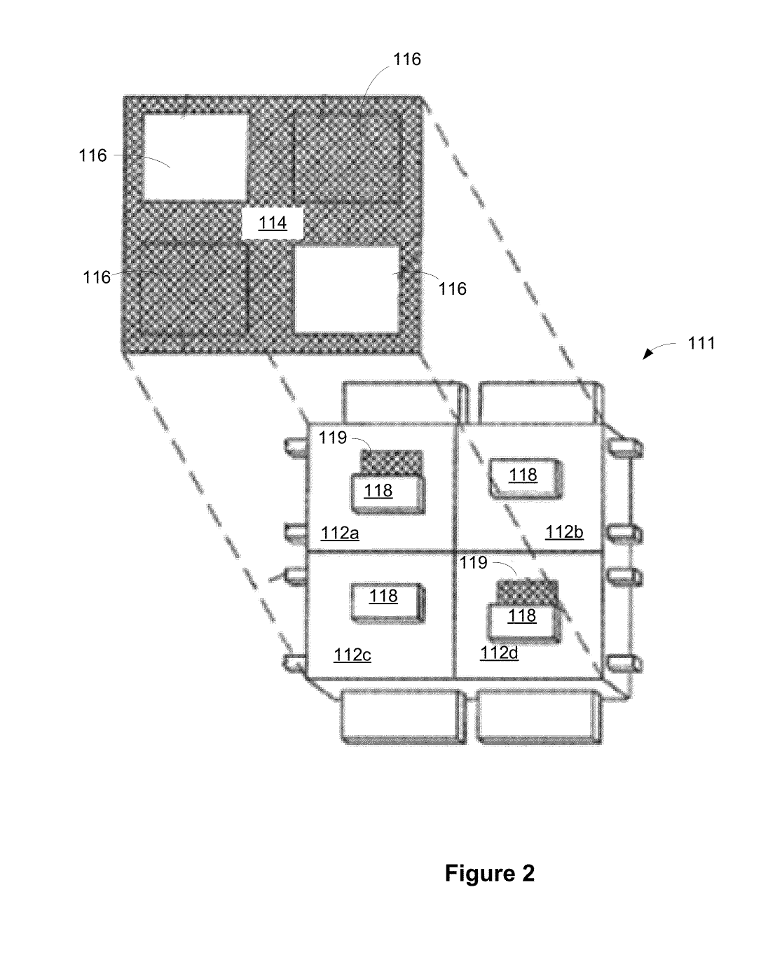

The electronic display 110 may include an arrangement for spatial light modulation. FIG. 2 illustrates a schematic diagram of an example of an arrangement for spatial light modulation of an interactive display. The arrangement 111 (which may be referred to as the “light modulation array”) may include a plurality of light modulators 112a-112d (generally, “light modulators 112”) arranged in rows and columns.

Each light modulator 112 may include a corresponding aperture 119. Each light modulator 112 may also include a corresponding shutter 118, or another means to switch the corresponding aperture 119 between an open position and a shut position. In order to render an image 114, the electronic display 110 may be configured to switch the light modulators in a time domain in accordance with a particular modulation scheme (the “first modulation scheme”). For example, to illuminate a pixel 116 of the image 114, a shutter 118 corresponding to the pixel is in an open position that permits transmittance of light from a display lighting system (not illustrated) through the corresponding aperture 119 toward a viewer (not illustrated). To keep the pixel 116 unlit, the corresponding shutter 118 is positioned such that it blocks light transmission through the corresponding aperture 119. Each aperture 119 may be defined by an opening provided in a reflective or light-absorbing layer, for example.

In the illustrated configuration, light modulators 112a and 112d are switched to an open position, whereas light modulators 112b and 112c are switched to a shut position. As a result of selectively switching the positions of the light modulators 112a-112d in accordance with the first modulation scheme, the electronic display 110 may render the image 114, as describe in more detail herein below. In some implementations, the first modulation scheme may be controlled by a computer processing arrangement that may be part of or may be communicatively coupled with the processor 104.

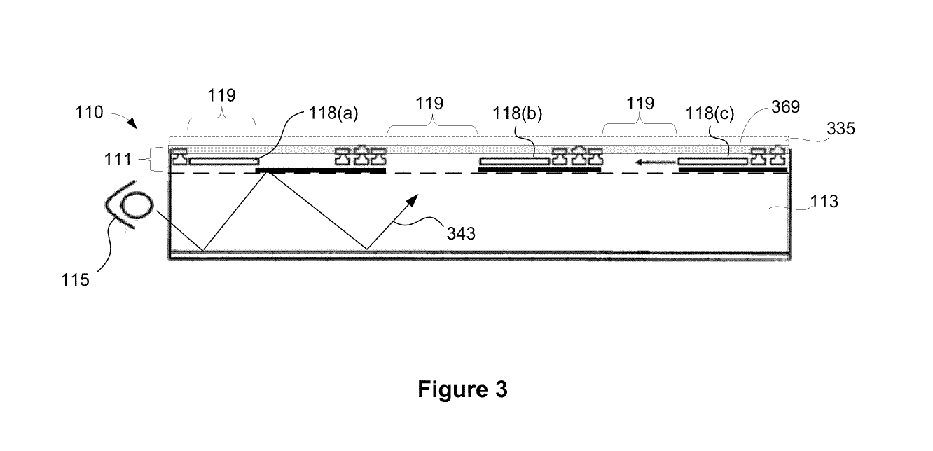

FIG. 3 is a cross sectional view of an interactive display incorporating a light modulation array. The electronic display 110 includes the light modulation array 111, an optical cavity 113, and a display lighting system 115. The light modulation array 111 may include any number of light modulators 112, as described hereinabove and illustrated in FIG. 2. As shown in the implementation illustrated in FIG. 3, each light modulator may include a corresponding shutter 118 and be configured to be switched between an open position and a shut position. In the illustrated implementation, for example, the shutters 118(b) and 118(c) are depicted in the open position, whereas, the shutter 118(a) is depicted in the closed position. Advantageously, the light modulators may be disposed on or proximate to a rear surface 369 of a transparent substrate 335.

In some implementations, the optical cavity 113 may be formed from a light guide that may be about 300 microns to about 2 mm thick, for example. The display lighting system 115 may be configured to emit light 343 into the optical cavity 113. Advantageously, at least a portion of the light 343 may undergo TIR and be distributed substantially uniformly throughout the optical cavity 113 as a result of judicious placement of light scattering elements (not illustrated) on one or more surfaces enclosing the optical cavity 113. For example, some light scattering elements may be formed in or on the rear enclosure of the optical cavity 113 to aid in redirecting the light 343 through the apertures 119.

The electronic display 110 may be referred to as a field sequential color (FSC) display, because, in some implementations, images are rendered by operating the display lighting system 115 so as to sequentially alternate the color of visible light emitted by the display lighting system 115. For example, the display lighting system 115 may emit a sequence of separate flashes of red, green and blue light. Synchronized with the sequence of flashes, a sequence of respective red, green and blue images may be rendered by appropriate switching, in accordance with the first modulation scheme, of the light modulators 112 in the light modulation array 111 to respective open or shut positions.

As a result of the persistence of vision phenomenon, a viewer of rapidly changing images, for example, images changing at frequencies of greater than 20 Hz, may perceive an image which is the combination, or approximate average, of the images displayed within a particular period. In some implementations, the first modulation scheme may be adapted to utilize this phenomenon so as to render color images while using as few as a single light modulator for each pixel of a display.

For example, in a color FSC display, the first modulation scheme may include dividing an image frame to be displayed into a number of sub-frame images, each corresponding to a particular color component (for example, red, green, or blue) of the original image frame. For each sub-frame image, the light modulators of the display are set into states corresponding to the color component's contribution to the image. The light modulators then are illuminated by a light emitter of the corresponding color. The sub-images are displayed in sequence at a frequency (for example, greater than 60 Hz) sufficient for the brain to perceive the series of sub-frame images as a single image.

As a result, an FSC display may require only a single light modulator per pixel, instead of a pixel requiring a separate spatial light modulator for each of three or more color filters. Advantageously, an FSC display may not suffer a loss of power efficiency due to absorption in a color filter and may make maximum use of the color purities available from modern light emitting diodes (LEDs), thereby providing a range of colors exceeding those available from color filters, i.e. a wider color gamut.

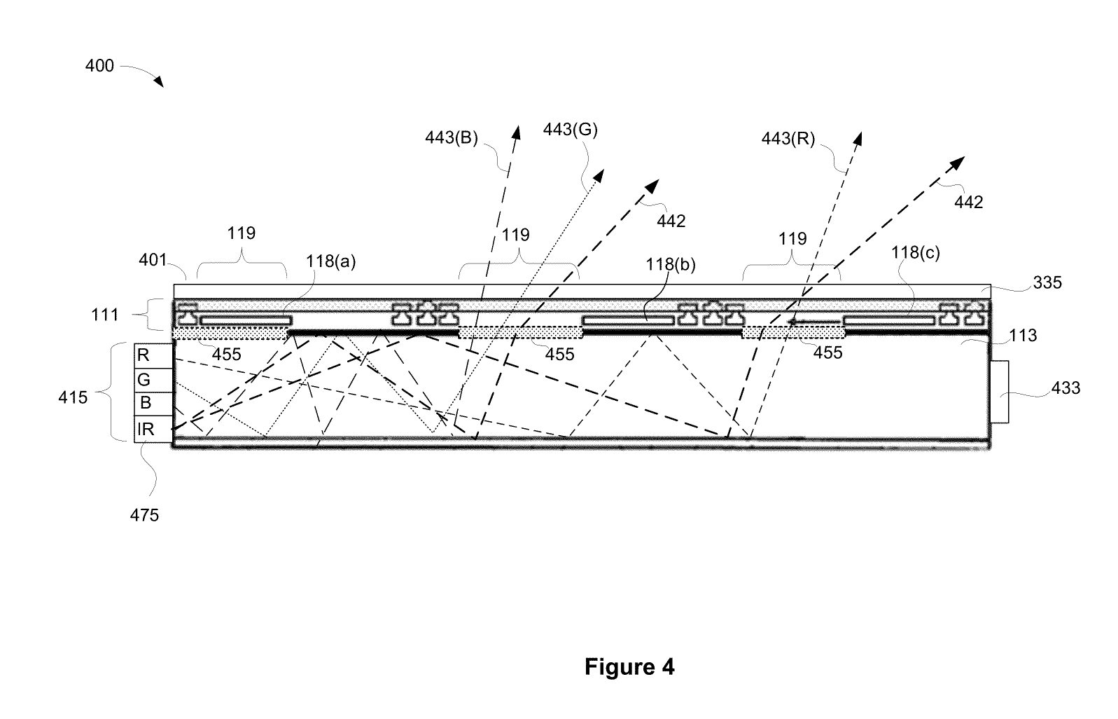

In some implementations the FSC display may be configured to emit changing patterns of visible and nonvisible light, for example infrared (IR) and near IR light. FIG. 4 illustrates an example of an interactive display according to an implementation. In the illustrated implementation, an interactive FSC display 400 includes a front surface 401, the transparent substrate 335 the light modulation array 111, the optical cavity 113 and a display lighting system 415. The interactive FSC display 400 may be configured to render color images, visible to a user through the front surface 401, by sequentially flashing one or more wavelength specific light emitters of the display lighting system 415 into the optical cavity 113, while synchronously performing spatial light modulation according to the first modulation scheme. In the illustrated implementation, the display lighting system 415 includes three wavelength specific visible light emitters, designated R (red), B (blue) and G (green) and an IR light emitter 475. It will be appreciated, however, that other arrangements of wavelength specific light emitters are possible. For example, in addition to, or instead of one or more of the RGB light emitters, light emitters of white, yellow, or cyan color may be included in the display lighting system 415.

In the illustrated implementation, the display lighting system 415 is a backlight, however implementations including only a frontlight or both a frontlight and a backlight are within the contemplation of the present disclosure.

The light modulation array 111 may include an array of light modulators as described hereinabove. As shown in the illustrated implementation, each light modulator may include corresponding shutter 118 and be configured to be switched between an open position and a shut position. For example, in the illustrated implementation, the shutters 118(a) and 118 (c) are each in the open position, and the shutter 118(b) is in the closed position.

Referring still to FIG. 4, IR emitter 475 may be configured to emit IR light 442 into optical cavity 113. Advantageously, at least a portion of the IR light 442 may undergo TIR and be distributed substantially uniformly throughout the optical cavity 113 as a result of judicious placement of light scattering elements (not illustrated) on one or more surfaces enclosing the optical cavity 113. For example, some light scattering elements may be formed in or on the rear enclosure of the optical cavity 113 to aid in redirecting the IR light 442 through the apertures 119.

Light directing features 455 may be configured such that IR light 442 is selectively turned, by, for example, refractive, diffractive or holographic means, whereas visible light 443 passes through the light directing features substantially unaffected. Light directing features 455 may be volume holographic features configured such that light at a particular wavelength is diffracted with high efficiency; and light at other wavelengths experiences little or no diffraction. More particularly, in the illustrated implementation, light emitted by IR emitter 475 experiences substantial diffraction so as to be redirected (or “structured”) into one or more particularly oriented lobes. Visible light emitted by the display lighting system 415, on the other hand, may pass through light directing features 455 with substantially no redirection.

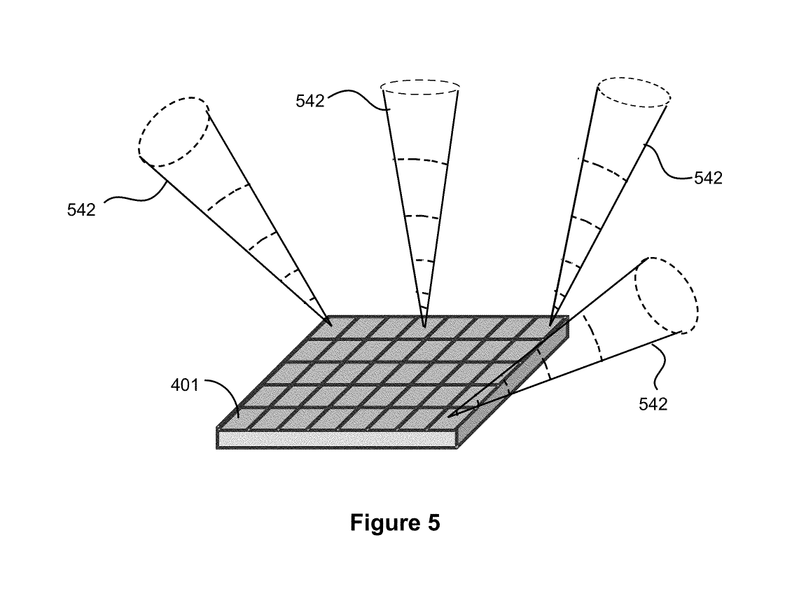

FIG. 5 illustrates an example of directionally structured lobes of object illuminating light. Each lobe 542 of IR light, as illustrated by FIG. 5, may be shaped approximately as a cone, and may be selectively disposed at a wide range of azimuth and elevation angles with respect to the front surface 401. Each aperture 119 may be selectively opened to illuminate the corresponding lobe 542 associated with the light directing feature 455 at that aperture. In this illustration, four apertures 119 are open, thus illuminating four lobes 542. A lobe 542 of IR light may interact with a finger (or hand, or stylus, or other hand-held object, not illustrated) controlled by a user and be reflected back toward front surface 401. The object may be on or above the front surface 401.

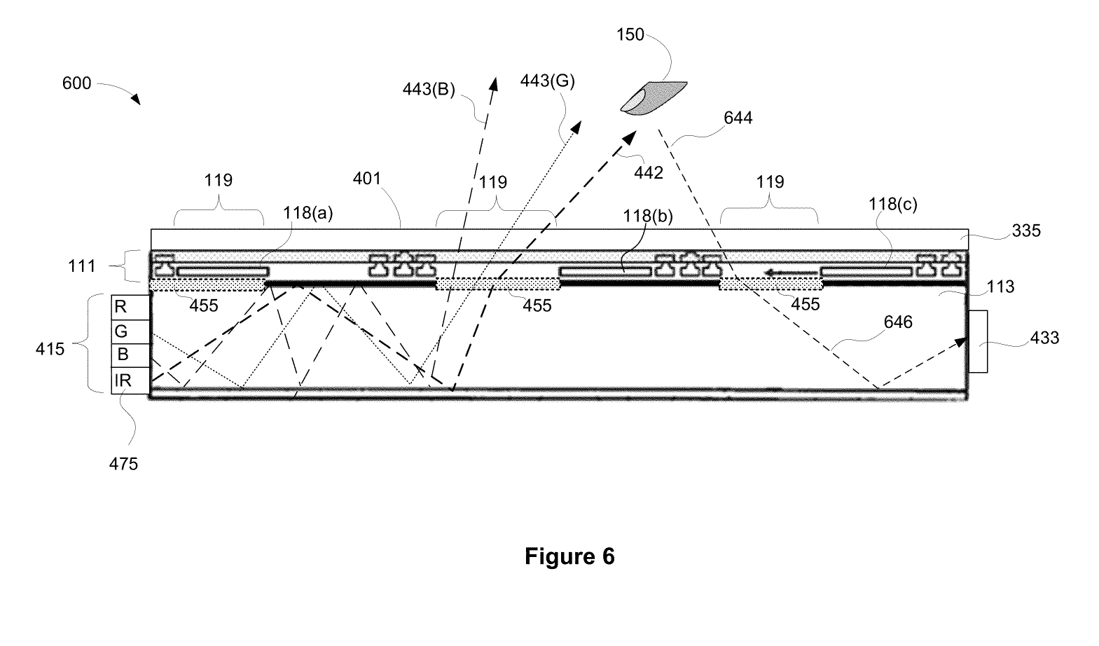

FIG. 6 illustrates an example of an interactive display according to an implementation. In the illustrated implementation, an interactive FSC display 600 includes the front surface 401, the transparent substrate 335, the light modulation array 111, the optical cavity 113 and the display lighting system 415. As illustrated in FIG. 6, when the object 150 interacts with object illuminating IR light 442, scattered IR light 644, resulting from the interaction, may be scattered back toward the front surface 401 and be received by IR light sensor 433. The object 150 may be, for example, a user's appendage, such as a hand or a finger, or it may be any physical object, hand-held or otherwise under control of the user, but is herein referred to, for simplicity, as the “object.”

Scattered IR light 644 may pass through light turning feature 455, enter optical cavity 113 and be at least partially received by IR light sensor 433. It will be appreciated that, as a result of optical reciprocity, each light turning feature 455 may absorb or reflect light reaching it from locations outside its respective, particularly oriented lobe(s). Therefore, for example, light reflected from an object not located within a lobe associated with a respective light turning feature 455 may not be redirected by light turning feature 455 and ultimately received by IR light sensor 433. Put another way, only light that is reflected from an object located within a lobe associated with a respective light turning feature 455 may be received by IR light sensor 433.

The IR light sensor 433 may be configured to output a signal representative of a characteristic of received IR light 646 resulting from interaction of the object illuminating IR light 442 with the object 150. For example, IR light sensor 433 may be configured to detect one or more characteristics of the received light 646 and output, to a processor (not illustrated), a signal representative of the detected characteristics. For example, the characteristics may include intensity, polarization, directionality, frequency, amplitude, amplitude modulation, and/or other properties. The processor may be configured to recognize, from the output of the IR light sensor 433 a characteristic, such as the location and/or motion, of the object 150.

Although a single IR light sensor 433 is illustrated in FIG. 6, it will be appreciated that any number of IR light sensors 433 may be contemplated. In some implementations, a wavelength of the IR light may be within a range (700 nm to 1000 nm wavelength, for example) such that IR light sensors 433 may include inexpensive silicon detectors.

In some implementations, there may be one or more optical components disposed between the front surface 401 and the IR light sensor 433. For example, an aperture array, a mask, a lens, a lens array, or another method of focusing light, increasing efficiency, or better discriminating angular versus spatial information for the scattered light 644 may be provided.

Spatial light modulation may be performed to produce a rendered image by switching a selected subset of the shutters 118 to an open position in accordance with the first modulation scheme. In some implementations, switching of the shutters 118 may be performed in synchronization with sequential flashing of the one or more wavelength specific light emitters of the display lighting system 415.

For example, a green wavelength specific light emitter of the display lighting system 415 may be configured to emit light 443(G) (“image rendering light”) into the optical cavity 113. Advantageously, at least a portion of the image rendering light 443(G) may undergo TIR and be distributed substantially uniformly throughout the optical cavity 113. A portion of the image rendering light 443(G) may be transmitted through one or more of the apertures 119 and contribute to the rendered image.

The present inventors have appreciated that an optical touch and gesture recognition functionality may be provided by using the object illuminating IR light 442. More particularly, light modulators may be switched in accordance with a second modulation scheme to selectively pass the object illuminating light 442 through at least one of the respective apertures.

In some implementations, the second modulation scheme may provide for interspersing of sub-frames during which the object illuminating IR light 442 is passed with sub-frames during which the image rendering light 443 is passed. For example, where the image rendering light 443 is passed in a series of groups of sub-frames of visible red, green and blue image patterns, the second modulation scheme may provide that the IR emitter 475 is flashed between each group of sub-frames. In some implementations a group of sub-frames may include ten sub-frames each of visible red, green and blue image patterns, for example.

In the implementations described above light directing features 455 were illustrated as being coplanar with apertures 119. Other arrangements are within the contemplation of the present disclosure, as described in more detail hereinafter.

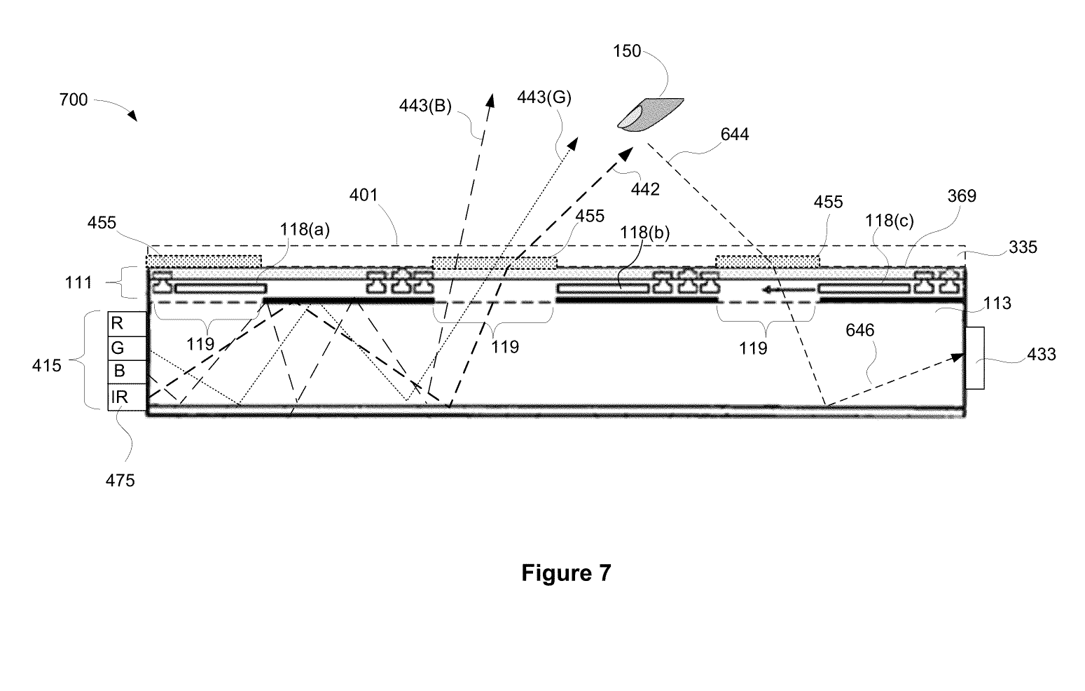

FIG. 7 illustrates a further example of an interactive display according to an implementation. In the illustrated implementation, an interactive FSC display 700 includes the front surface 401, the transparent substrate 335, the light modulation array 111, the optical cavity 113 and the display lighting system 415. In the illustrated implementation, light directing features 455 are disposed proximate to a rear surface 369 of transparent substrate 335.

As illustrated in FIG. 7, when the object 150 interacts with object illuminating IR light 442, scattered IR light 644, resulting from the interaction, may be scattered back toward the front surface 401 and be received by IR light sensor 433. Scattered IR light 644 may pass through light turning feature 455, enter optical cavity 113 and be at least partially received by IR light sensor 433. The IR light sensor 433 may be configured to output a signal representative of a characteristic of received IR light 646 resulting from interaction of the object illuminating IR light 442 with the object 150.

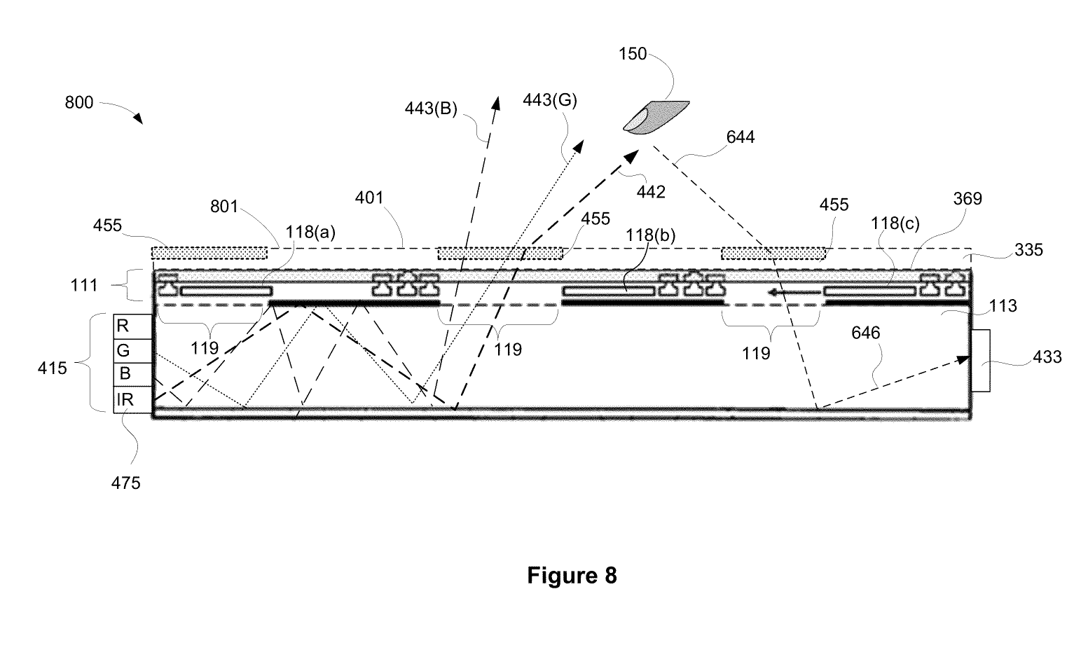

FIG. 8 illustrates another example of an interactive display according to an implementation. In the illustrated implementation, an interactive FSC display 800 includes the front surface 401, the transparent substrate 335, the light modulation array 111, the optical cavity 113 and the display lighting system 415. In the illustrated implementation, light directing features 455 are disposed proximate to a front surface 801 of transparent substrate 335.

As illustrated in FIG. 8, when the object 150 interacts with object illuminating IR light 442, scattered IR light 644, resulting from the interaction, may be scattered back toward the front surface 401 and be received by IR light sensor 433. Scattered IR light 644 may pass through light turning feature 455, enter optical cavity 113 and be at least partially received by IR light sensor 433. The IR light sensor 433 may be configured to output a signal representative of a characteristic of received IR light 646 resulting from interaction of the object illuminating IR light 442 with the object 150.

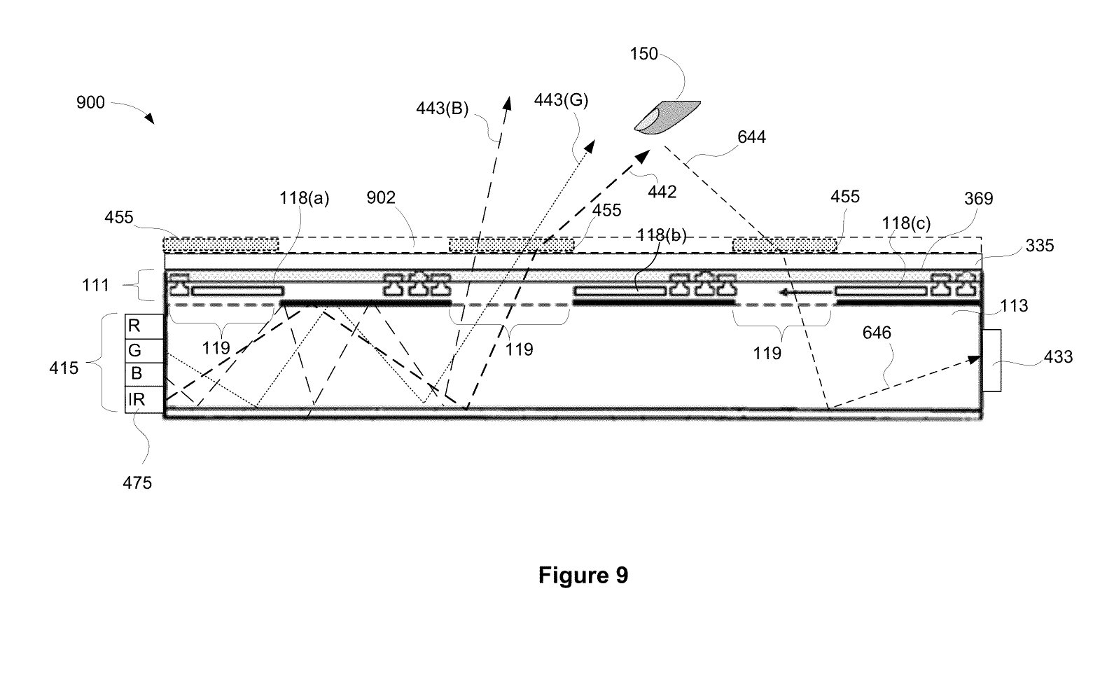

FIG. 9 illustrates a yet further example of an interactive display according to an implementation. In the illustrated implementation, an interactive FSC display 900 includes the transparent substrate 335, the light modulation array 111, the optical cavity 113, the display lighting system 415 and a front layer 902. In the illustrated implementation, light directing features 455 are disposed within the front layer 902. Front layer 902, in some implementations, may be a transparent substrate such as glass, for example.

As illustrated in FIG. 9, when the object 150 interacts with object illuminating IR light 442, scattered IR light 644, resulting from the interaction, may be scattered back toward the front surface 401 and be received by IR light sensor 433. Scattered IR light 644 may pass through light turning feature 455, enter optical cavity 113 and be at least partially received by IR light sensor 433. The IR light sensor 433 may be configured to output a signal representative of a characteristic of received IR light 646 resulting from interaction of the object illuminating IR light 442 with the object 150.

In some implementations, the second modulation scheme may provide, periodically, a “blank” sub-frame, during which the display lighting system is caused to turn off all light sources. During such a blank sub-frame, a level of ambient light proximate to the interactive FSC display 500 may be determined, for example. In some implementations, the light sensors may be configured to sense the pattern of shadows cast by an object 150 on the FSC display 500 during such blank sub-frames. The shutters for all the pixels may be closed during such blank sub-frames, in some implementations.

As indicated above, outputs of the IR sensor 433 may indicate one or more characteristics of the object 150. Such characteristics include location, motion, and image characteristics of the object 150. Particular implementations for obtaining location and motion characteristics, which may relate to a user input including a touch or a gesture, are described hereinbelow. In such implementations, the second modulation scheme may include selectively opening of light modulators according to one or more scanning patterns. In order to provide a better understanding of features and benefits of the presently disclosed techniques, illustrative examples of scanning patterns will now be described.

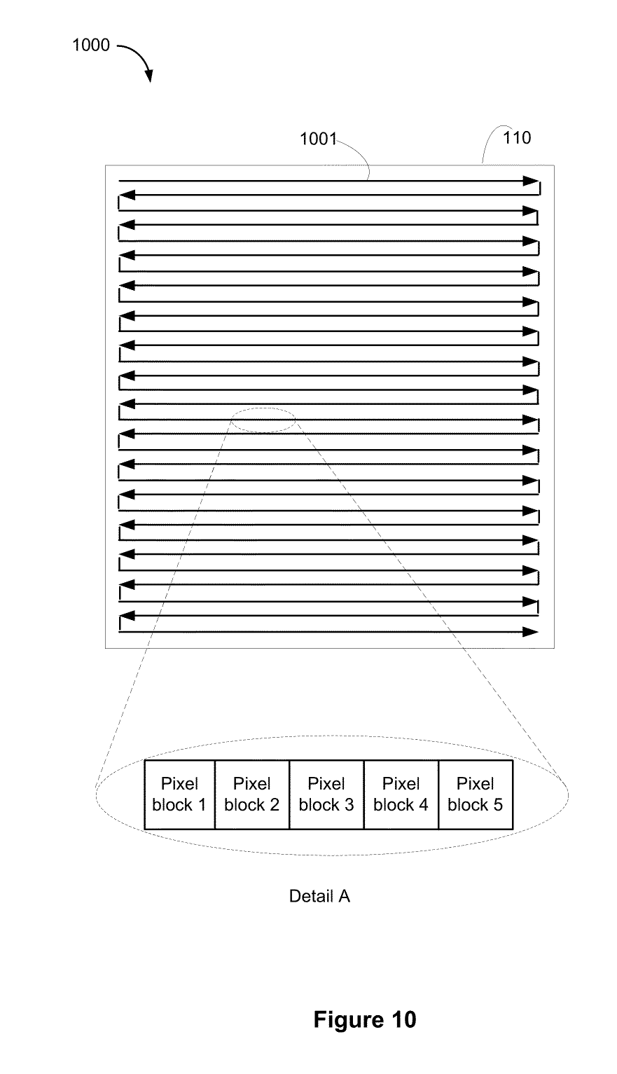

In some implementations, a scanning pattern may resemble a raster scan. FIG. 10 illustrates an example of a scanning pattern for a second modulation scheme in accordance with some implementations. In the illustrated arrangement 1000, the second modulation scheme includes selectively switching of light modulators to the open position in a temporal sequence according to a scanning pattern 1001. As a result, object illuminating light may be passed through a sequentially through a series of apertures, or blocks of apertures according to the scanning pattern 1001, where each aperture is associated with a respective pixel. As a result, substantially all of the viewing area of the electronic display 110 may be encompassed by the scanning pattern 1001.

In some implementations, a raster scan line may be composed of a series of adjacent apertures. However, taking into account that apertures are typically much smaller in size than the object 150, it may be advantageous to scan blocks of apertures. For example, referring to Detail A, each pixel block may include multiple apertures and be approximately one to 25 square millimeters in size. Two or more blocks in a successive series of blocks of apertures may include at least some apertures in common. That is, in some implementations, there may be an overlap of apertures between a first block of apertures and a second, succeeding or preceding block of pixels.

It will be appreciated that the illustrated scanning pattern 1001 is only an illustrative aspect of a feature of the second modulation scheme. Other scanning patterns are within the contemplation of the present disclosure. For example, a spiral scanning pattern may be implemented.

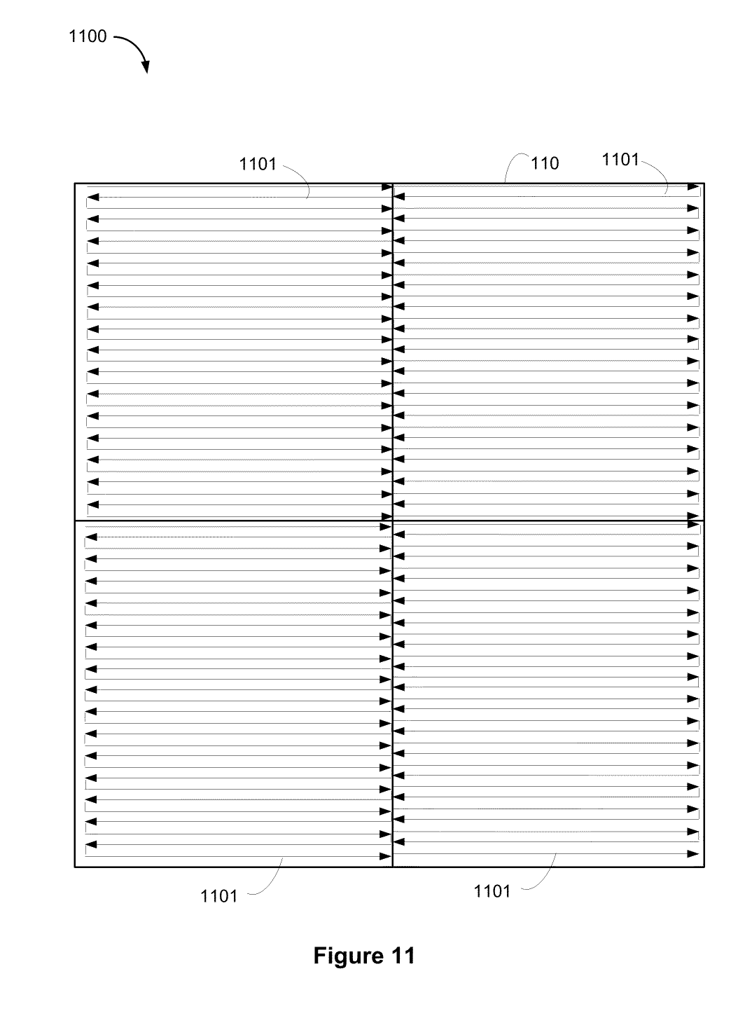

FIG. 11 illustrates a further example of a scanning pattern for a second modulation scheme in accordance with some implementations. In such implementation, a total viewing area of the electronic display 110 is treated as separate regions, with each separate region being separately scanned. In the illustrated implementation 1100, for example, the total viewing area of the electronic display 110 is treated as four separate quadrants. Scanning of each region by way of a scanning pattern 1101 may be performed, advantageously, in parallel. As a result, in each sub-frame in which object illuminating light is to be emitted through an open aperture, at least one aperture of a respective scanning pattern in each quadrant may be switched to an open position. Although in the illustrated implementation, a similar scanning pattern 1101 is executed in four similarly sized quadrants, it will be appreciated that other arrangements are within the contemplation of the present disclosure. One or more the separate regions may be of a different size, for example. As a further example, a scanning pattern for any region may be different from a scanning pattern region for another region.

It will be appreciated that selectively switching of light modulators to the open position in a temporal sequence according to a scanning pattern as described above may be performed in synchronization with flashes of IR emitter 475. Referring again to FIG. 6, blocks of light modulators may be switched to the open position sequentially according to the scanning pattern, in synchronization with flashes of IR emitter 475, for example.

When the object 150 is approximately above a block of light modulators switched to the open position, the object 150 will interact with the emitted IR light 442. The scattered light 644 resulting from interaction of the emitted IR light 442 with the object 150 may be received by the IR sensor 433. The IR sensor 433 may be configured to output, to a processor (not shown), a signal representative of a characteristic of the received, redirected scattered light 646. The processor may be configured to recognize, from the output of the IR sensor 433, the characteristic of the object 150, such as location and relative motion, for example.

As noted above, each light turning feature 455 may be configured so as to absorb or reflect light reaching it from locations outside its respective, particularly oriented lobe(s). As a result, only light that is reflected from an object located within a lobe associated with a respective light turning feature 455 may be received by IR light sensor 433. The lobe may also be referred to as the “field of view” of the light turning feature.

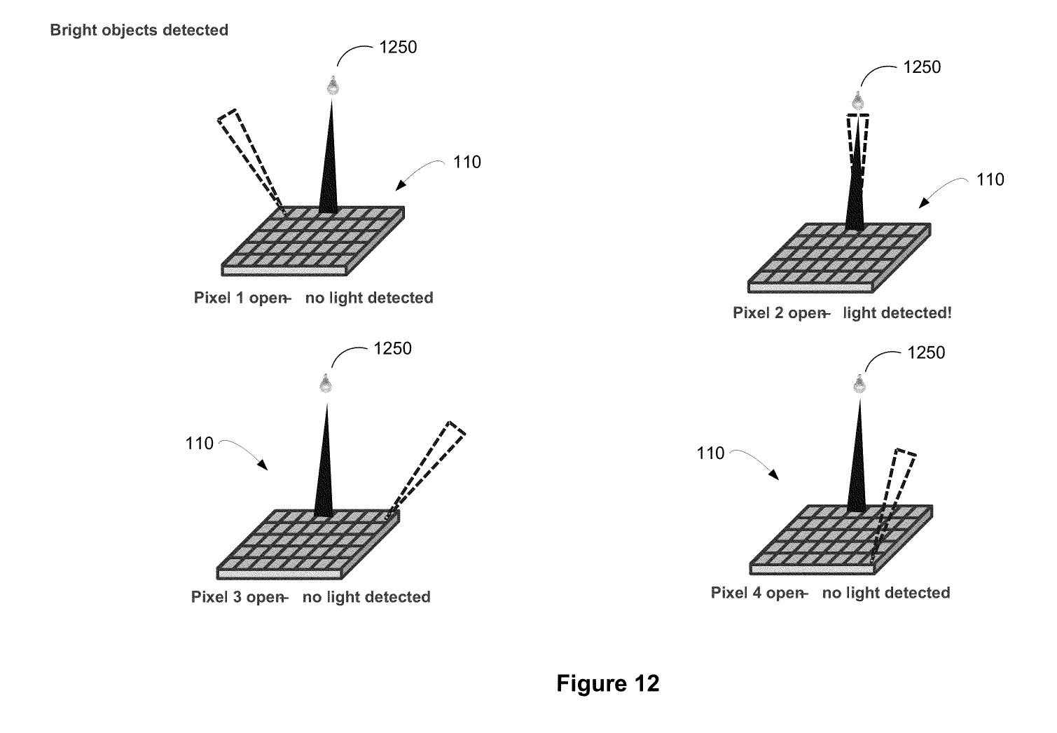

FIG. 12 illustrates a technique for detecting a bright object, according to some implementations. Bright object 1250 is illustrated as being located in a particular geometric position with respect to a front surface of display 110. It will be appreciated that bright object 1250 may be “bright”, in some implementations, as a result of scattering object illuminating IR light emitted from the display. In other implementations bright object 1250 may be an IR light source, or may scatter ambient IR light or IR light from an external source (not illustrated).

Each of a plurality of pixels, as disclosed hereinabove, may be associated with a respective light turning feature 455 and a respective aperture 119. Each light turning feature 455 may have a particular field of view, which may or may not overlap with a field of view of a different light turning feature. In the illustrated example, bright object 1250 may be detected when the respective aperture associated with “Pixel 2” is open. When the respective aperture associated with “Pixel 2” is shut, the bright object may be undetected even when apertures associated with at least some other pixels are open. For example, in the illustrated implementation, the respective fields of view of light turning features associated with pixels 1, 3 and 4 do not include bright object 1250.

It will be appreciated that the respective apertures of successive pixels may be opened in a temporal sequence according to the second modulation scheme. For example, the temporal sequence may correspond to the raster scan patterns illustrated in FIGS. 10 and 11. The second modulation scheme may include opening apertures to collect IR light at timer intervals interspersed between color sub-frames. The second modulation scheme may include a compressive sensing pattern such as a pseudorandom pattern, or be performed according to a discrete cosine basis, for example.

Referring again to FIG. 6, each opened aperture may couple, into the optical cavity 113, IR light received within a specific angular cone corresponding to the field of view of the light turning element associated with the opened aperture. As described hereinabove, the received IR light 646 may be detected by IR light sensor 433. As a result, a location and/or motion of the bright object 1250 may be detected.

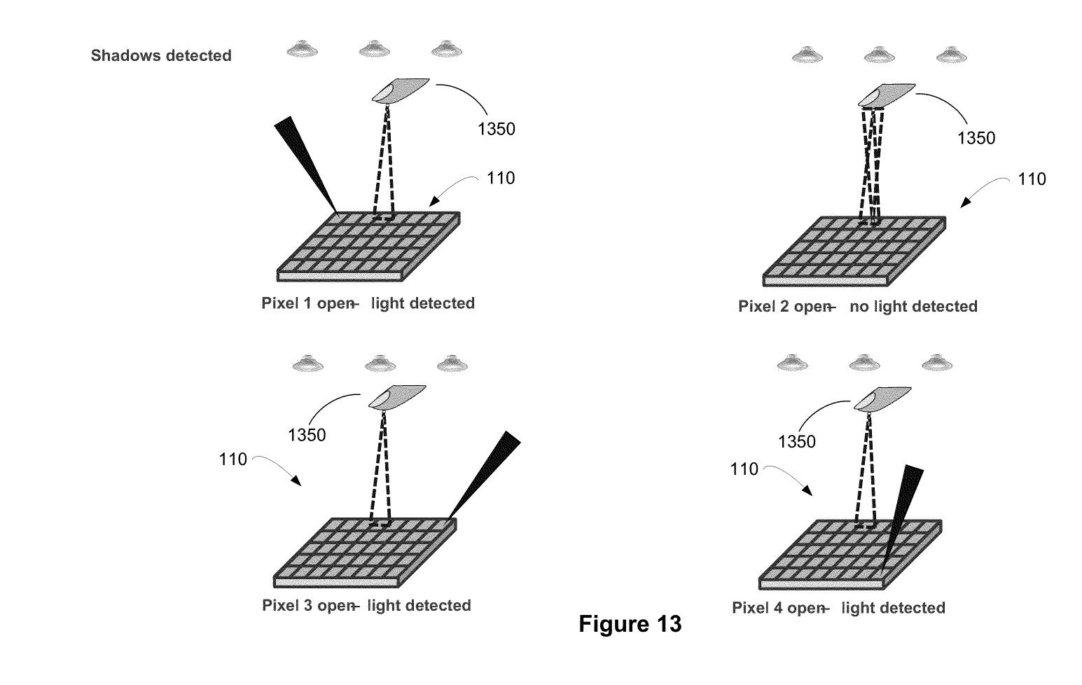

FIG. 13 illustrates a technique for detecting a dark object, according to some implementations. Dark object 1350 is illustrated as being located in a particular geometric position with respect to a front surface of display 110. It will be appreciated that dark object 1350 may be regarded as a shadow cast as a result of dark object 1350 being interposed between display 110 and a source of IR light, for example.

Each of a plurality of pixels may be associated with a respective light turning feature 455 and a respective aperture 119. Each light turning feature 455 may have a particular field of view, which may or may not overlap with a field of view of a different light turning feature. In the illustrated example, a shadow cast by dark object 1350 may be detected when the respective aperture associated with “Pixel 2” is open. When the respective aperture associated with “Pixel 2” is shut, the shadow may be undetected even when apertures associated with at least some other pixels are open. For example, in the illustrated implementation, the respective fields of view of light turning features associated with pixels 1, 3 and 4 do not include dark object 1350.

It will be appreciated that the respective apertures of successive pixels may be opened in a temporal sequence according to the second modulation scheme. For example, the temporal sequence may correspond to the raster scan patterns illustrated in FIGS. 10 and 11. The second modulation scheme may include opening apertures to collect IR light at timer intervals interspersed between color sub-frames. The second modulation scheme may include a compressive sensing pattern such as a pseudorandom pattern, or be performed according to a discrete cosine basis, for example.

Referring again to FIG. 6, each opened aperture may couple, into the optical cavity 113, IR light received within a specific angular cone corresponding to the field of view of the light turning element associated with the opened aperture. As described hereinabove, the received IR light 646 may be detected by IR light sensor 433. As a result, a location and/or motion of the dark object 1350 may be detected.

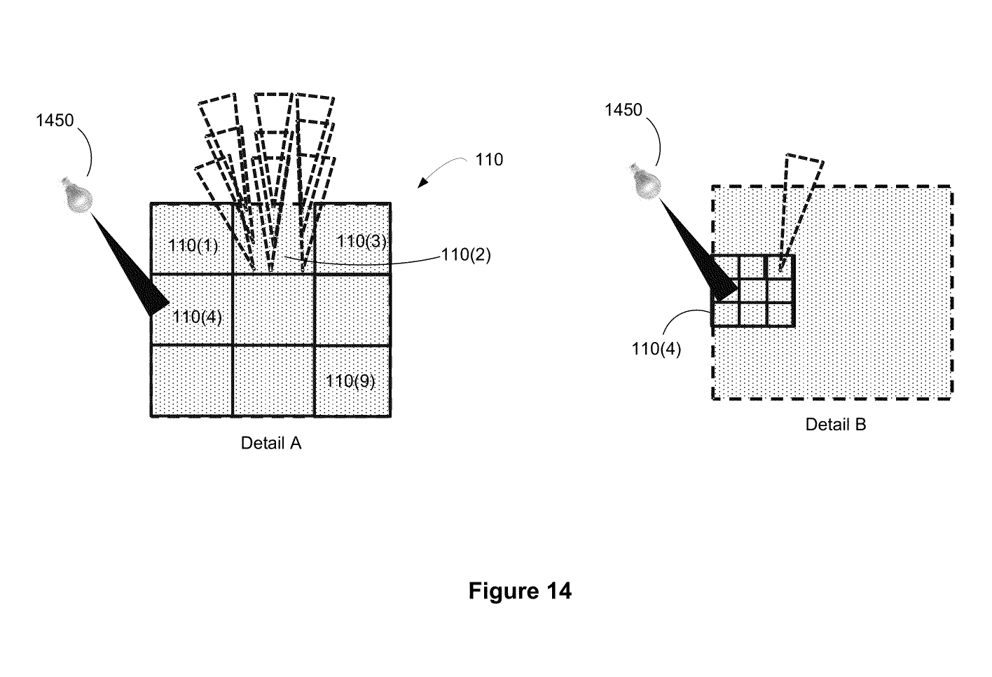

FIG. 14 illustrates an example of a scanning strategy for the second modulation scheme in accordance with some implementation. In the illustrated example respective apertures of successive clusters (“blocks”) of pixels may be opened in a temporal sequence according to the second modulation scheme. For example, the display area may be divided into a number blocks of pixels. In the illustrated, simplified example, the display area 110 is divided into nine blocks 110(1), 110(2) . . . 110(9), each block including nine pixel apertures. Each of the pixel apertures in a given cluster may be opened simultaneously, and the successive blocks of pixel apertures may be opened in a temporal sequence that may correspond to the raster scan patterns illustrated in FIG. 10 or 11, for example.

When an object is detected in a particular pixel block, a subsequent raster scan may be performed using a smaller subset of pixel apertures, or individual pixel apertures in a temporal sequence. In the example illustrated in FIG. 14, object 1450 may be detected during a first, relatively course scan at pixel block 110(4), Detail A. A subsequent, finer scan may then be performed using only pixel apertures within pixel block 110(4), Detail B.

As described above, the second modulation scheme may include opening apertures to collect IR light at timer intervals interspersed between color sub-frames. The second modulation scheme may include a compressive sensing pattern such as a pseudorandom pattern, or be performed according to a basis that is sparse with respect to the objects to be sensed, such as according to a discrete cosine basis, for example. In some implementations the pattern may include a binary code pattern, such as “Gray” codes typically used for error prevention when reading naturally-occurring binary codes, for example, as well as other possible patterns.

It will be appreciated that IR light may be emitted by IR light source 475, for example, and/or detected by IR light detector 433, for example during sub-frames during which image rendering light is also being emitted. In some implementations, IR light sensor signals may be back correlated with knowledge of the pixel aperture settings in a relevant sub-frame. Such a correlation may be used, for example, to make an object location determination, to prioritize what areas of the display to raster scan, reduce the number of necessary sub-frames, increase the scanning speed, and/or increase location resolution for a given number of sub-frames.

In any of the above-described implementations, the second modulation scheme may be configured such that, during a fraction of the sub-frames all the RGB and IR light turn-off, and the photo-sensitive elements may be configured to sense the pattern of shadows cast by object 250 on the display. For this measurement, the shutters for all the pixels may be closed.

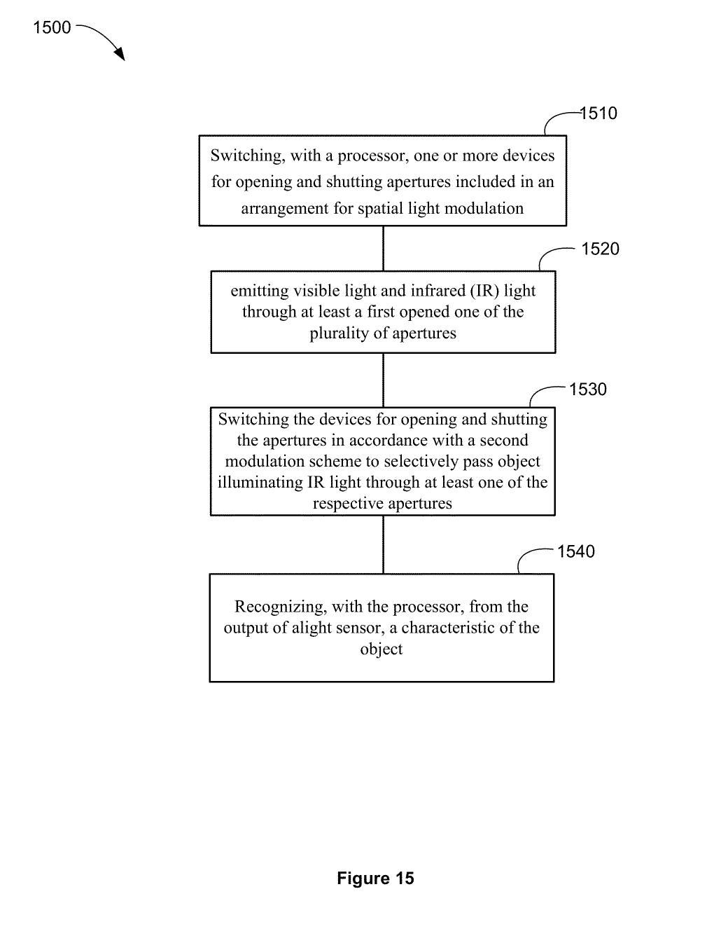

FIG. 15 illustrates an example of a process flow for touch and gesture recognition with an interactive FSC display according to an embodiment. At block 1510 of process 1500, one or more devices for opening and shutting apertures included in an arrangement for spatial light modulation may be switched by a processor. The apertures may be included in an arrangement for spatial light modulation. In some implementations, the devices for opening and shutting the apertures may be switched in accordance with a first modulation scheme to render an image. As described hereinabove, a field sequential color (FSC) display, that includes the arrangement for spatial light modulation, has a display front surface and a viewing area. The FSC display may include a light directing arrangement including at least one light turning feature, the light turning feature being configured to redirect IR light emitted through the opened aperture into at least one lobe, and to pass visible light emitted by the display lighting system through the opened aperture with substantially no redirection. The FSC display may also include at least one infrared (IR) light sensor configured to output a signal representative of a characteristic of received IR light, the received IR light resulting from scattering of the at least one lobe of IR light by an object.

At block 1520, visible light and IR light may be emitted through at least a first opened one of the plurality of apertures.

At block 1530, the devices for opening and shutting the apertures may be switched in accordance with a second modulation scheme to selectively pass object illuminating IR light through at least one of the respective apertures. Advantageously, the object illuminating IR light may be at least partially unrelated to the image.

At block 1540, the processor may recognize, from the output of the light sensor, a characteristic of the object. The characteristic may include one or more of a location, or a motion of the object, or image data. Advantageously, the processor may control the display, responsive to the characteristic.

Thus, improved implementations relating to an interactive FSC display have been disclosed. In some of the above described implementations, the display lighting system may include light sources configured to be fully or partially modulated at some frequency or signal pattern. In such implementations, the processor may include and/or be coupled with light sensor readout circuitry that includes an active or passive electrical band-pass frequency filter or other means to correlate the modulator signal pattern. In addition to modulation, the intensity of the light sources may be scaled to the (possibly lower or higher) appropriate amount of light for scanning rather than displaying information.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an apparatus as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a field sequential color (FSC) display, having a display front surface and a viewing area, the FSC display including:
a display lighting system that includes at least one visible light emitter and at least one infrared (IR) light emitter;
an arrangement for spatial light modulation, the arrangement including a plurality of apertures, and devices for opening and shutting the apertures; and
a light directing arrangement including at least one light turning feature; wherein:
the display lighting system is configured to emit visible light and IR light through at least a first opened one of the plurality of apertures; and
the light turning feature is configured to redirect IR light emitted through the opened aperture into at least one lobe, and to pass visible light emitted by the display lighting system through the opened aperture with substantially no redirection.

2. The apparatus of claim 1, further including:
at least one IR light sensor configured to output a signal representative of a characteristic of received IR light, the received IR light resulting from scattering of the at least one lobe of IR light by an object.

3. The apparatus of claim 2, further including a processor that receives the outputted signal and is configured to recognize, from the outputted signal a characteristic of the object.

4. The apparatus of claim 3, wherein the light turning feature is further configured to pass and redirect IR light received by scattering from the object when the object is located within the at least one lobe and to absorb or reflect IR light arriving from outside the at least one lobe.

5. The apparatus of claim 3, wherein the processor controls the FSC display, responsive to the characteristic.

6. The apparatus of claim 3, wherein the characteristic is one or more of a location, or a motion of the object.

7. The apparatus of claim 1, wherein the display lighting system includes one or both of a backlight and a frontlight.

8. The apparatus of claim 1, wherein the arrangement for spatial light modulation includes a plurality of shutter assemblies.

9. The apparatus of claim 1, wherein the light directing arrangement is coplanar with the apertures.

10. The apparatus of claim 1, wherein the light directing arrangement is disposed in a plane between the apertures and the front surface.

11. The apparatus of claim 1, wherein the display lighting system emits visible light during a first number of sub-frames and emits IR light during a second number of sub-frames.

12. The apparatus of claim 11 wherein the IR light emitter is flashed during a sub-frame where image data is being displayed.

13. The apparatus of claim 1, further including a processor and at least one IR light sensor configured to output a signal representative of a characteristic of received IR light, the received IR light resulting from scattering of the at least one lobe of IR light by an object, wherein:
the devices for opening and shutting the apertures are switched in accordance with a first modulation scheme to render an image;
the IR light sensor is configured to output, to the processor, a signal representative of a characteristic of the received IR light; and
the processor is configured to switch the devices for opening and shutting the apertures in accordance with a second modulation scheme to selectively pass object illuminating IR light through at least one of the respective apertures, the object illuminating IR light being at least partially unrelated to the image; and recognize, from the output of the light sensor, a characteristic of the object.

14. The apparatus of claim 13, wherein the second modulation scheme includes a sensing pattern interspersed between visible image patterns.

15. The apparatus of claim 14, wherein the sensing pattern includes a raster scan.

16. The apparatus of claim 13, wherein the characteristic is one or more of a location, or a motion of the object.

17. An apparatus comprising:
a field sequential color (FSC) display, having a display front surface and a viewing area, the FSC display including:
an arrangement for spatial light modulation, the arrangement including a plurality of apertures, and devices for opening and shutting the apertures;
means for emitting visible light and infrared (IR) light through at least a first opened one of the plurality of apertures; and
a light directing arrangement including at least one light turning feature; wherein:
the light turning feature is configured to redirect IR light emitted through the opened aperture into at least one lobe, and to pass visible light emitted by the display lighting system through the opened aperture with substantially no redirection.

18. The apparatus of claim 17, further including a processor and at least one IR light sensor configured to output a signal representative of a characteristic of received IR light, the received IR light resulting from scattering of the at least one lobe of IR light by an object, wherein:
the devices for opening and shutting the apertures are switched in accordance with a first modulation scheme to render an image;
the IR light sensor is configured to output, to the processor, a signal representative of a characteristic of the received IR light; and
the processor is configured to switch the devices for opening and shutting the apertures in accordance with a second modulation scheme to selectively pass object illuminating IR light through at least one of the respective apertures, the object illuminating IR light being at least partially unrelated to the image; and recognize, from the output of the light sensor, a characteristic of the object.

19. A method comprising:
switching, with a processor, one or more devices for opening and shutting apertures included in an arrangement for spatial light modulation, wherein:
the devices for opening and shutting the apertures are switched in accordance with a first modulation scheme to render an image;
a field sequential color (FSC) display, has a display front surface and a viewing area, the FSC display including the arrangement for spatial light modulation; and
the FSC display includes:
a light directing arrangement including at least one light turning feature, the light turning feature being configured to redirect IR light emitted through the opened aperture into at least one lobe, and to pass visible light emitted by the display lighting system through the opened aperture with substantially no redirection;
and at least one infrared (IR) light sensor configured to output a signal representative of a characteristic of received IR light, the received IR light resulting from scattering of the at least one lobe of IR light by an object;
emitting visible light and infrared (IR) light through at least a first opened one of the plurality of apertures;
switching the devices for opening and shutting the apertures in accordance with a second modulation scheme to selectively pass object illuminating IR light through at least one of the respective apertures, the object illuminating IR light being at least partially unrelated to the image; and
recognizing, with the processor, from the output of the light sensor, a characteristic of the object.
